(19) United States
(12) Patent Application Publication
(10) Pub. No.: US 2022/0148401 A1
(43) Pub. Date: May 12, 2022

(54) DETECTING SYSTEM FOR FIRE

(71) Applicant: Osense Technology Co., Ltd., Taipei City (TW)

(72) Inventors: FU-KUEI CHEN, Taipei City (TW); YOU-KWANG WANG, Taipei City (TW); HSIN-PIAO LIN, Taoyuan City (TW)

(73) Assignee: Osense Technology Co., Ltd., Taipei City (TW)

(21) Appl. No.: 17/386,550

(22) Filed: Jul. 28, 2021

Related U.S. Application Data
(60) Provisional application No. 63/110,378, filed on Nov. 6, 2020.

(30) Foreign Application Priority Data
Feb. 9, 2021 (TW) 110104873

(51) Int. Cl. G08B 17/06; G08B 25/04; G01S 13/06

(52) U.S. Cl. CPC G08B 17/06; G01S 13/06; G08B 25/04

(57) ABSTRACT

A detecting system for fire is provided. The detecting system includes a sensing device, a control center, and a physical circuit. The sensing device is disposed in a sensing area. The sensing device is for obtaining target information, environmental information, and location information, and for outputting sensing information. The sensing area includes a sub-sensing area corresponding to the sensing device. The control center is coupled to the sensing device. The control center is for outputting integrated information based on sensing information. The physical circuit is for coupling the sensing device and the control center. The sensing device obtains the unique location information corresponding to the sub-sensing area according to the physical circuit.

### CROSS REFERENCE TO RELATED APPLICATION

This application claims the priority benefit of U.S. provisional application Ser. No. 63/110,378, filed on Nov. 6, 2020. This application also claims the priority benefits of Taiwan application serial no. 110104873, filed on Feb. 9, 2021. The entirety of each of the above-mentioned patent applications is hereby incorporated by reference herein and made a part of this specification.

### BACKGROUND

### Technical Field

The disclosure relates to a detecting system, and more particularly to a detecting system for fire.

### Description of Related Art

In order to prevent fire, various alarm systems or detecting systems have come into being. Moreover, when a fire occurs, fire scenario information is very important and urgently needed. However, the fire may impact the aforementioned systems and lead to malfunctions. Therefore, how to effectively collect the fire scenario information and provide reliable information when a fire occurs is a topic of concern to people skilled in the art.

The information disclosed in this BACKGROUND section is only for enhancement of understanding of the disclosure, and the BACKGROUND section may therefore contain information that does not form the prior art that is already known to people of ordinary skill in the art. Further, the information disclosed in the BACKGROUND section does not mean that one or more problems to be resolved by one or more embodiments of the disclosure was acknowledged by people of ordinary skill in the art.

### SUMMARY

The disclosure provides a detecting system for fire that may effectively collect fire scenario information and provide reliable information when a fire occurs.

The detecting system for fire of the disclosure includes a sensing device, a control center, and a physical circuit. The sensing device is disposed in a sensing area. The sensing device is for obtaining target information, environmental information, and location information, and for outputting sensing information. The sensing area includes a sub-sensing area corresponding to the sensing device. The control center is coupled to the sensing device. The control center is for outputting integrated information according to the sensing information. The physical circuit is for coupling the sensing device and the control center. The sensing device obtains the unique location information corresponding to the sub-sensing area according to the physical circuit.

Based on the above, the disclosure provides a detecting system for fire that may effectively collect fire scenario information and provide reliable information when a fire occurs.

In order to make the aforementioned features and advantages of the disclosure comprehensible, embodiments accompanied with drawings are described in detail below.

### BRIEF DESCRIPTION OF THE DRAWINGS

FIG. 1 is a schematic diagram of a detecting system for fire according to an embodiment of the disclosure.

FIG. 2 is a schematic diagram of a sensing device for detecting fire according to an embodiment of the disclosure.

FIG. 3 is an operation flowchart of a detecting system for fire according to an embodiment of the disclosure.

### DESCRIPTION OF THE EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

Furthermore, unless otherwise defined, all terms (including technical and scientific terms) used herein have the same meaning as commonly understood by one of ordinary skill in the art to which the disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

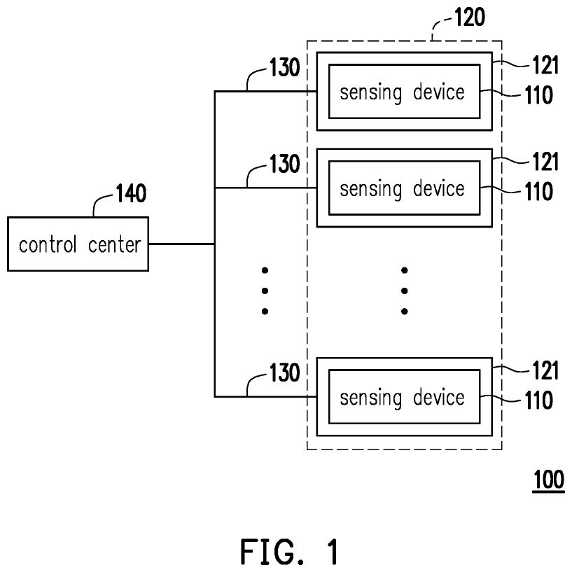

FIG. 1 is a schematic diagram of a detecting system for fire according to an embodiment of the disclosure. With reference to FIG. 1, a detecting system 100 may include a sensing device 110, a control center 140, and a physical circuit 130. The sensing device 110 may be disposed in a sensing area 120 for obtaining target information, environmental information, and location information, and for outputting sensing information. The sensing area 120 may include a sub-sensing area 121 corresponding to the sensing device. In this embodiment, the number of sub-sensing areas may be one or more, and the disclosure is not limited thereto. The control center 140 is coupled to the sensing device 110. The control center 140 is for outputting integrated information according to the sensing information. The physical circuit 130 is for coupling the sensing device 110 and the control center 140. The sensing device 110 obtains the unique location information corresponding to the sub-sensing area 121 according to the physical circuit 130.

Specifically, in this embodiment, the sensing area 120 may include various locations such as a residence, an office, a restaurant, a school, a library, or a public area, but the disclosure is not limited thereto. Moreover, in this embodiment, the sub-sensing area 121 may include various rooms or spaces such as a living room, a study room, a bedroom, a bathroom, and the like, but the disclosure is not limited thereto. For example, in an embodiment, the sensing area 120 may be a residence. Therefore, the sub-sensing area 121 may include, for example, a living room, a study room, a bedroom, and a bathroom. The sensing device 110 may be disposed respectively in the living room, the study room, the bedroom, and the bathroom. In addition, the sensing device 110 may detect whether a target exists in the corresponding sub-sensing area 121 to output the target information. In this embodiment, the target may include a person, an animal, or various targets set by a user, but the disclosure is not limited thereto. Moreover, the sensing device 110 may detect temperature, humidity, smoke concentration, and other parameters in the corresponding sub-sensing area 121 to output the environmental information. Furthermore, the sensing device 110 may detect the location information of the corresponding sub-sensing area 121. After the aforementioned detection, the sensing device 110 may output the sensing information to the control center 140 through the physical circuit 130. Next, the control center 140 may integrate the sensing information of each sub-sensing area 121 to output the integrated information. The control center 140 may further determine whether to deliver the integrated information to a client according to the integrated information. In an embodiment, the client may include a resident, a building administrator, a security member, a fire control center, and the like, but the disclosure is not limited thereto.

It should be noted that when a fire occurs, wireless signal transmission may be interfered to a certain extent due to the damage to base stations or power supply. In this embodiment, the physical circuit 130 may include a signaling line circuit (SLC), but the disclosure is not limited thereto. In addition, the SLC may be used to transmit data and supply power. More importantly, the sensing device 110 coupled to the SLC may obtain the unique location information corresponding to the sensing device 110 according to SLC distribution. Therefore, employing the physical circuit 130 such as the SLC may effectively ensure that interference of signal transmission and power supply may be reduce when a fire occurs. In this way, the detecting system 100 may effectively collect fire scenario information and provide reliable information when the fire occurs.

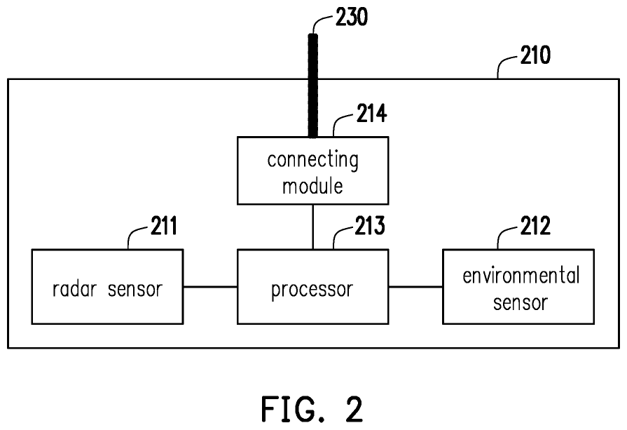

FIG. 2 is a schematic diagram of a sensing device for detecting fire according to an embodiment of the disclosure. With reference to FIG. 1 and FIG. 2, the sensing device 210 includes a radar sensor 211, an environmental sensor 212, a processor 213, and a connecting module 214. The radar sensor 211 is for detecting a target in the corresponding sub-sensing area 121 to obtain the target information. The environmental sensor 212 is for obtaining the environmental information. The processor 213 couples the radar sensor 211 and the environmental sensor 212. The processor 213 is for outputting sensing information according to the target information, the environmental information, and the location information. The connecting module 214 is coupled to the processor 213. The connecting module 214 is for obtaining the unique location information corresponding to the sub-sensing area, and the processor 213 delivers the sensing information to the control center 140 through the connecting module 214.

In this embodiment, the radar sensor 211 may include an electronic device with sensing functions such as an mmWave radar sensor, a passive infrared sensor (a PIR sensor), or the like, but the disclosure is not limited thereto. In addition, the radar sensor 211 may detect the location of the target to determine whether the target exists in the sub-sensing area 121. Moreover, the target information may include the location of the target for subsequent use by the control center 140.

In this embodiment, the environmental sensor 212 may include an ionization environmental sensor and a light scattering environmental sensor, but the disclosure is not limited thereto. In addition, the environmental sensor 212 may obtain parameters such as environmental temperature, environmental humidity, and environmental smoke concentration of the corresponding sub-sensing area 121. Similarly, the environmental information may include environmental temperature, environmental humidity, and environmental smoke concentration for subsequent use by the control center 140.

In this embodiment, the connecting module 214 may include an SLC module, but the disclosure is not limited thereto. The connecting module 214 is for obtaining power supply from the physical circuit. In addition, the sensing device operates according to the power supply, and the connecting module 214 is for obtaining the unique location information corresponding to the sensing device through a distribution of the physical circuit. In this embodiment, the processor 213 may include a central processing unit (CPU), a microprocessor control unit (MCU), or a field programmable gate array (FPGA), but the disclosure is not limited thereto. The processor 213 may be used to output the sensing information according to the target information, the environmental information, and the location information. In addition, the processor 213 may deliver the sensing information to the control center 140 through the connecting module 214.

It should be noted that in this embodiment, the connecting module 214 may be in-built in the sensing device 210. However, in another embodiment, the connecting module 214 may be coupled to the sensing module 210 through an external connection, but the disclosure is not limited thereto. In other words, a conventional sensing device may have the function of obtaining the location information by externally connecting to the connecting module 214. In addition, by modifying the original circuit of the sensing area 120, the original circuit may have the functions of transmitting data and supplying power at the same time. In this way, the user may effectively collect information about the fire scene and provide reliable information when a fire occurs without abandoning the original sensing device.

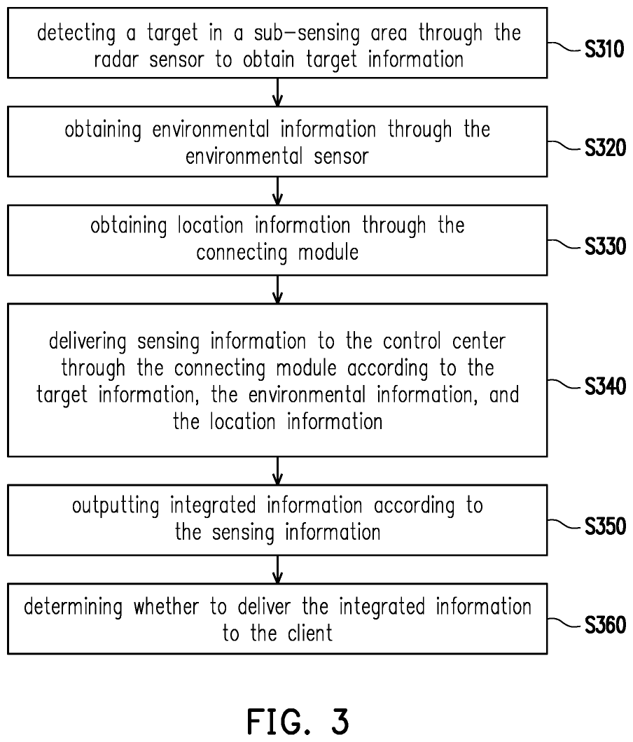

FIG. 3 is an operation flowchart of a detecting system for fire according to an embodiment of the disclosure. With reference to FIG. 1 to FIG. 3, in step S310, the radar sensor 211 may detect a target in the sub-sensing area 121 to obtain the target information. The radar sensor 211 may sense the location in the sub-sensing area 121 to determine whether the target exists in the sub-sensing area 121. In step S320, the environmental sensor 212 may detect environmental temperature, environmental humidity, and environmental smoke concentration of the sub-sensing area 121 to output the environmental information. In step S330, the connecting module 214 may obtain the location information corresponding to the sub-sensing area 121 through the physical circuit 230. In step S340, the processor may deliver the sensing information to the control center through the connecting device 214 according to the target information, the environmental information, and the location information.

It should be noted that the processor 213 may determine a target behavior of the target according to the target information provided by the radar sensor 211 and the environmental information provided by the environmental sensor 212. In addition, the processor 213 may determine a content of the sensing information according to the target behavior. For example, in an embodiment, the sensing device 110 may be disposed in the sub-sensing area 121 such as a kitchen, and a target in the sub-sensing area 121 is cooking. The processor 213 may determine the correlation between the current environmental information and the target behavior according to the target behavior and the environmental information to determine the content of the sensing information. In this embodiment, since the environmental temperature and the environmental smoke concentration in the environmental information are caused by the target behavior of cooking, and a parameter value of the environmental information is less than a fire alarm threshold value, the processor 213 may determine the content of the sensing information as a non-fire incident. In another embodiment, if the correlation between the environmental information and the target behavior is low, or the parameter value of the environmental information is greater than or equal to the fire alarm threshold value, the processor 213 may determine the content of the sensing information as a fire incident.

In step S350, the control center 140 may identify the sub-sensing area 121 which the sensing information corresponds to according to the physical circuit 130. In addition, the control center 140 may integrate the sensing information from each sub-sensing area 121 to output the integrated information. The integrated information includes the number of targets in the sensing area 120 and the location information corresponding to each target. In addition, the integrated information may include whether a fire incident exists in the environmental information corresponding to each sub-sensing area 121. In step S360, the control center 140 may determine whether to deliver the integrated information to the client according to the integrated information. In an embodiment, since a fire incident exists in the environmental information corresponding to a certain sub-sensing area 121, the control center 140 may determine to deliver the integrated information to the client. In an embodiment, the client may include a resident, a building administrator, a security member, a fire control center, and the like, but the disclosure is not limited thereto. In this way, in an initial stage of the fire incident, relevant personnel may perform corresponding treatments based on the integrated information to reduce the impact of the fire.

In summary, the detecting system for fire of the disclosure may effectively collect fire scenario information and provide reliable information when a fire occurs.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A detecting system for fire, comprising:
a sensing device, disposed in a sensing area for obtaining target information, environmental information, and location information, and for outputting sensing information, wherein the sensing area comprises a sub-sensing area corresponding to the sensing device;
a control center, coupled to the sensing device for outputting integrated information according to the sensing information; and
a physical circuit for coupling the sensing device and the control center, wherein the sensing device obtains the location information which is unique and corresponds to the sub-sensing area according to the physical circuit.

2. The detecting system according to claim 1, wherein the sensing device comprises:
a radar sensor for detecting a target in the sub-sensing area corresponding to the sensing device to obtain the target information;
an environmental sensor for obtaining the environmental information;
a processor, coupled to the radar sensor and the environmental sensor for outputting the sensing information according to the target information, the environmental information, and the location information; and
a connecting module, coupled to the processor and the physical circuit for obtaining the location information, wherein the processor delivers the sensing information to the control center through the connecting module.

3. The detecting system according to claim 2, wherein the radar sensor comprises a millimeter-wave radar sensor, and the target information comprises a location of the target.

4. The detecting system according to claim 2, wherein the processor determines whether the target exists in the sub-sensing area according to the location of the target.

5. The detecting system according to claim 2, wherein the environmental sensor comprises at least one of an ionization environmental sensor and a light scattering environmental sensor, and the environmental information comprises an environmental temperature and an environmental smoke concentration.

6. The detecting system according to claim 2, wherein the physical circuit comprises a signaling line circuit, the connecting module comprises a signaling line circuit module, the connecting module is for obtaining a power supply from the physical circuit, the sensing device operates based on the power supply, and the connecting module is for obtaining the location information which is unique and corresponds to the sensing device through a distribution of the physical circuit.

7. The detecting system according to claim 6, wherein the control center identifies the sub-sensing area which the sensing information corresponds to according to the physical circuit.

8. The detecting system according to claim 7, wherein the integrated information comprises a number of the targets in the sensing area and the location information respectively corresponding to the targets.

9. The detecting system according to claim 1, further comprising a client, wherein the control center determines whether to deliver the integrated information to the client according to the integrated information.

10. The detecting system according to claim 2, wherein the processor determines a target behavior of the target according to the target information for determining a content of the sensing information.
